(19) United States
(12) Patent Application Publication
(10) Pub. No.: US 2014/0379303 A1
(43) Pub. Date: Dec. 25, 2014

(54) IDENTIFYING UTILITY RESOURCE DIVERSION

(71) Applicant: Oracle International Corporation, Redwood Shores, CA (US)

(72) Inventors: Pushpa CHANDRASHEKARAIAH, Los Altos, CA (US); Moorthy KAVASSERI, Okemos, MI (US); Shuo TIAN, Daly City, CA (US)

(21) Appl. No.: 13/923,506

(22) Filed: Jun. 21, 2013

(51) Int. Cl. G06Q 50/06; G06Q 10/06

(52) U.S. Cl. CPC G06Q 50/06; G06Q 10/06
USPC 702/189

(57) ABSTRACT

Systems, methods, and other embodiments associated with analyzing utility data to identify diversion of a utility resource within a distribution system of a utility provider are described. In one embodiment, a method includes analyzing, by at least a processor of a computer, the utility data based, at least in part, on diversion rules to identify characteristics that correlate with diversion of the utility resource. The utility data is data from multiple independent sources of the utility provider. The example method may also include calculating a theft score that identifies a likelihood that the utility resource is being diverted from a location in a geographic area based, at least in part, on the identified characteristics.

### BACKGROUND

Energy diversion refers to the unauthorized taking of a utility resource (e.g., electric energy) from a distribution system of a utility provider. Entities that divert energy typically tamper with metering equipment or use an unauthorized physical tap into the distribution system to gain illicit access to the energy. Furthermore, identifying energy diversion can be a difficult task because of the wide geographical area of the distribution system and regulations related to privacy and property rights of customers. Additionally, while a utility provider may collect a large volume of data about the distribution system, analyzing the data is difficult because it is spread across disparate systems of the utility provider.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a method associated with analyzing utility data to identify energy diversion.

FIG. 2 illustrates another embodiment of a method associated with analyzing utility data to identify energy diversion.

FIG. 3 illustrates one example of a method associated with analyzing utility data to identify energy diversion.

FIG. 4 illustrates tables of example factors for determining a theft score.

FIG. 5 illustrates an embodiment of a computing system configured with a diversion analyzer.

### DETAILED DESCRIPTION

Systems, methods and other embodiments are described that are associated with analyzing utility data to identify possible energy diversion within a distribution system of a utility provider. Consider that the utility provider (e.g., electric company, gas company, water company, etc.) operates a utility distribution system (e.g., electric distribution grid) that spans a wide geographic area. The distribution system can include thousands of meters, substations, and other resources. Accordingly, the distribution system also includes many points that are vulnerable to energy diversion (i.e., diversion of electricity, gas, water, etc.). However, physically monitoring or patrolling the distribution system to identify locations of energy diversion is difficult and often impractical.

Further consider that with the advent of smart metering, the utility provider collects a much larger volume of information via electronic communication systems and networks than previously collected by manual means. For example, instead of reading each meter in the distribution system once per month, each meter is read once per hour. This change in the granularity of meter readings represents a 730 fold increase in the amount of readings and likewise in an amount of data for each meter in the distribution system. Furthermore, in addition to the increase in the amount of data, the data from meter readings is stored in one system while billing data and customer data are stored in and controlled in different systems. Thus, managing and correlating meter data with customer data and/or billing data is a complex task especially considering the large volume of data that can be involved.

Accordingly, in one embodiment, data from the disparate systems (e.g., meter data, customer data, billing data) is collected together and correlated using energy diversion analytics to identify likely locations of energy diversion events. In this way, a utility provider may exploit the abundance of data to identify and prevent energy diversion from the utility distribution system.

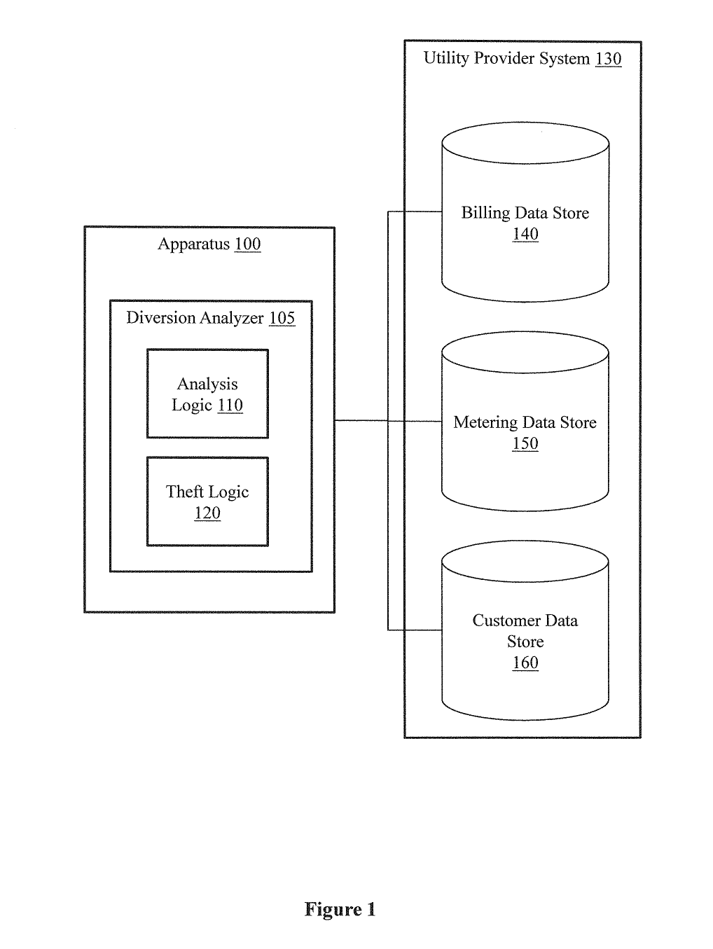

With reference to FIG. 1, one embodiment of an apparatus 100 associated with analyzing utility data to identify energy diversion within a distribution system of a utility provider is illustrated. In general, for purposes of simplicity of discussion within this disclosure, the utility provider will be discussed as an electric utility that provides electric power through a utility distribution system. In one example, the utility distribution system is an electric grid with electric meters installed at customer locations. However, the utility provider may also be a natural gas provider, a potable water provider, a telephony/Internet provider, or more generally any utility or resource provider that operates with applicable distribution systems where a resource is supplied for payment (e.g., gas, water, etc.). Accordingly, within this disclosure energy diversion references diversion of a utility resource (e.g., electric, gas, water, telephony) distributed by a utility provider through a distribution system and is not limited to only energy resources (e.g., gas, electric) but is intended to also include other utility resources (e.g., water, telephony, etc.).

Continuing with FIG. 1, the apparatus 100 is, for example, a computer, server, or other device that is configured to execute instructions and process data with at least a processor and memory. The apparatus 100 includes a diversion analyzer 105 that is configured with analysis logic 110 and theft logic 120. In one embodiment, the diversion analyzer 105 may be implemented as an executable application stored in a storage medium or as part of another executable application. In one embodiment, the analysis logic 110 is configured to communicate with a utility provider system 130 to retrieve utility data from multiple separate sources within the utility provider system 130. In one example, the communication is performed using a network communication interface to communicate over a network and access remote data.

The utility provider system 130 is, for example, an enterprise system of computers that independently stores data about different aspects (e.g., consumption, billing, customers, etc.) of a utility distribution system (e.g., electric grid). In one embodiment, the utility provider system 130 includes independent data stores for each set of data. That is, the utility provider system 130 includes different enterprise systems (e.g., billing, meter reading, maintenance, customer care) that collect and store utility data independently without referencing utility data collected by or managed by other programs in the utility provider system 130. Accordingly, utility data from one enterprise system (e.g., metering system) is not correlated with utility data from another enterprise system (e.g., billing system) within the larger utility provider system 130. In one embodiment, the apparatus 100 is configured to compare and identify patterns or characteristics that may exist within the utility data by correlating the utility data from different systems.

For example, the utility provider system 130 includes a billing data store 140, a metering data store 150, and a customer data store 160, which are separate data stores and independently maintained by a respective enterprise system. Of course in other embodiments, the utility provider system 130 may include a different number (e.g., 2, 4, 10, etc.) of sets of data stores or that one or more of the enterprise systems can be combined to contain multiple types of data. Each of the data stores 140-160 is, for example, a separate database that is stored in a separate location and maintained by an enterprise system. The billing data store 140 may include a billing history for each meter in the distribution system, payment history information, and so on. The metering data store 150 may contain data from meter readings, meter data management (MDM) information, and consumption data for each meter in the distribution system. The customer data store 160 may include customer contact information (e.g., name, address, etc.), customer payment history, payment plan information, and so on.

To initiate a diversion analysis, the diversion analyzer 105 is executed to process an analysis request. The diversion analyzer 105 may include a user interface configured to allow entry of request parameters. The request may also be received from a remote location. For example, the analysis logic 110 may receive a request to analyze a particular geographic area within the utility distribution system for energy diversion. In one embodiment, the request also specifies a period of time for which to retrieve data. The period of time is, for example, specific (e.g., 3/14/12-6/13/12) or relative (e.g., previous week/month/year). In response to the request, the analysis logic 110 retrieves utility data that is relevant to the geographic area and/or specified period of time from one or more databases: the billing data store 140, the metering data store 150, and/or the customer data store 160. The retrieved utility data may then be stored in the data warehouse of the apparatus 100.

Furthermore, the analysis logic 110 is configured to apply different analytics to the utility data stored in the data warehouse to correlate the utility data and identify characteristics that are consistent with energy diversion. Once the analysis logic 110 has identified the characteristics within the utility data, the theft logic 120 is configured to, for example, calculate a theft score for locations within the geographic area to determine a likelihood that a given location is experiencing energy diversion. In this way, the apparatus 100 correlates data from disparate data stores 140-160 of the utility provider system 130 to identify relationships in the utility data that are consistent with energy diversion and thus expose locations within the utility distribution system where energy diversion is likely occurring.

Additionally, in one embodiment, the analysis logic 110 is configured to apply the different analytics to the utility data at different levels of granularity. That is, for example, the analysis logic 110 is configured to first apply the analytics to the requested utility data at a higher level of granularity and then move to lower levels of granularity as locations of possible energy diversion are identified. Consider that the requested utility data can be abstracted into different levels of granularity that correspond to different levels in the utility distribution system (e.g., distribution network>station>substation>feeder>transformer>street>house). Each of the different levels of granularity includes, for example, a different number of meters or end service points and also may include different distribution points that are not end service points but are locations further up the utility distribution system.

The distribution points are, for example, metering devices that are located at intermediate points in the utility distribution system and measure an amount of energy resources that flow through the distribution point. Distribution points may also be defined that are aggregated data sources. That is, in one example, a distribution point is aggregated meter data from all end points within a particular region that is combined into a single reference point. For example, a distribution point can be located at an entry to a neighborhood, at a point just before one or more substations, and so on.

Consider that if the requested data is for an area defined by, for example, a city border, then the analysis logic 110 may begin by analyzing the requested data at granularity level that segments the city into several sub-regions (e.g., distribution substations). The sub-regions include several different regions within the city that each includes, for example, thousands of individual meters and/or one or more distribution points (e.g., feeder points). Accordingly, the theft logic 120 may then generate a theft score for the analysis at each sub-region and if the score satisfies a condition that indicates energy diversion, the analysis logic 110 proceeds to apply the analytics at a next level of granularity (e.g., feeder, transformer).

For each subsequent refined level of granularity there are fewer meters and/or distribution points, but each of the sub-regions includes at least two additional sub-regions (e.g., feeders). For example, the sub-station level data is broken into sub-parts that define feeder level data. In this way, the analysis logic 110 and the theft logic 120 are configured to iteratively analyze the requested utility data at different levels of granularity until a sub-component of the requested geographic region is identified that likely includes an occurrence of energy diversion. Additionally, in one embodiment, a default level of granularity controls the analysis of the requested utility data, however, the request may specify a preferred level in order to modify the default level.

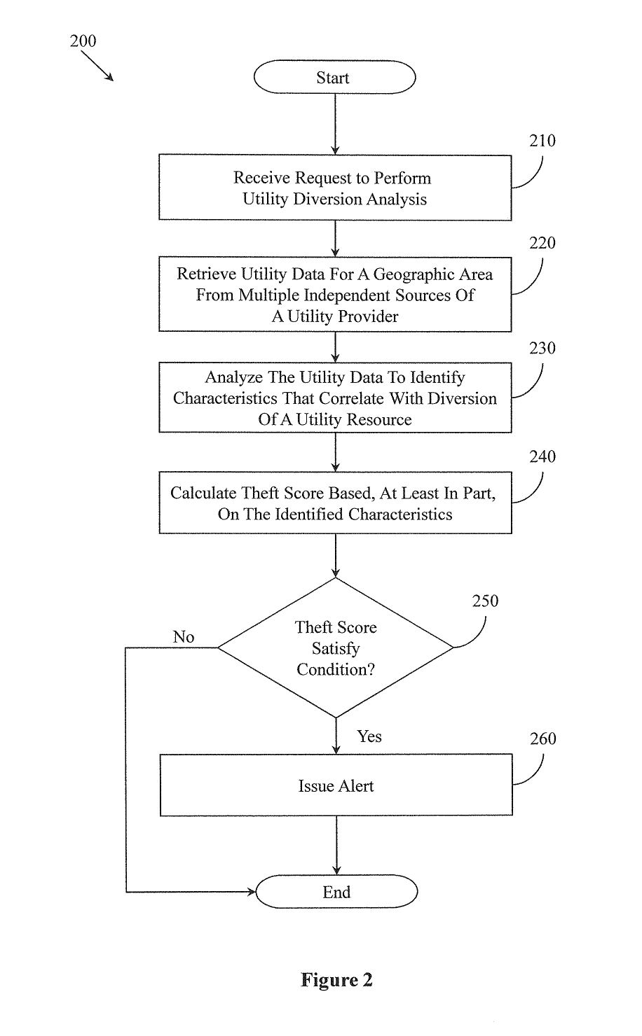

Further details of analyzing utility data to identify energy diversion within the distribution system of the utility provider will be discussed with reference to FIG. 2. FIG. 2 illustrates one embodiment of a method 200 associated with analyzing utility data to identify energy diversion. FIG. 2 will be discussed from the perspective of the apparatus 100 of FIG. 1.

At 210, the method initiates by receiving a request to perform a utility diversion analysis. In one embodiment, the utility diversion analysis includes correlating utility data from independent sources (e.g., data stores 140-160) of a utility provider as described previously. The correlation attempts to identify relationships (e.g., spikes, patterns of low usage, missed payments along with large variance in usage, and so on) and anomalies (e.g., loss of energy) within the utility data that are indicative of energy diversion within the distribution system of the utility provider.

In one embodiment, the request includes parameters that specify a geographic area within which to perform the utility diversion analysis and/or may also specify to perform the analysis on data from a specified period of time. The geographic area is, for example, a region within the distribution system of the utility provider. For example, the geographic area may be a single address/household that correlates with a single meter in the distribution system. The geographic area may encompass larger areas and may be indicated by a postal code, a subdivision code, or another indicator of a sub-region in the utility distribution system.

In one embodiment, the geographic area is defined by a collection of distribution points. For example, a distribution point is a point (e.g., feeder point) in the utility distribution system through which the energy resource flows. That is, the distribution point is a measurement/data point through which the energy resource is supplied to two or more downstream distribution points or meters. In one example, a distribution point occurs before a segmentation of the distribution chain into two or more different paths in the distribution system. For example, a distribution point occurs at an entry point of the energy resource into a sub-division/neighborhood. Additionally, a distribution point may be an aggregation of data from end point meters that occur downstream from a defined point of the distribution point or a distribution point may be a separate meter located at a physical location in the utility distribution system that is upstream from end point meters. In still another embodiment, the apparatus 100 may analyze the entire distribution system of the utility provider for energy diversion in, for example, a piecemeal manner.

At 220, the apparatus 100 retrieves utility data associated with the geographic area specified by the request. To retrieve the utility data, the apparatus 100, for example, queries multiple sources (e.g., data stores 140-160) within an enterprise system (e.g., utility provider system 130) of the utility provider. The multiple sources include different databases that each store utility data (e.g., billing, metering, etc.) about locations within the geographic area. The databases are, in general, collections of data from disparate departmental systems of the utility provider. Accordingly, the databases are part of independent enterprise systems under the larger system 130 of the utility provider. That is, each of the databases may be independent and may not share or correlate data between each other. Thus, the apparatus 100 is configured to collect the retrieved utility data together into a data store (e.g., database) for analysis and comparisons.

At 230, the retrieved utility data is analyzed based, at least in part, on diversion rules to identify characteristics that correlate with diversion (i.e., energy diversion) of a utility resource. The diversion rules are, for example, metrics that define when the utility data is indicative of energy diversion. In one embodiment, the metrics include thresholds, patterns, anomalies, relationships between different data, selected errors, and more generally any identifier of data that is consistent with energy diversion. Such metrics may be predefined from previously observed events that have been associated with energy diversion/theft. For example, the metrics may include a customer changing payment plans (e.g., switching from a plan to standard billing), irregular billing/payment patterns (e.g., not paying in last x months), validate edit estimate (VEE) exceptions, previously identified tamper events, customer having a threshold amount owed on an account (e.g., over X dollars), a mismatch between the total energy flowing into a region verses a total amount billed for the region, load/consumption profiles, service orders, outage events, variation from expected values in consumption, unusual payment pattern changes, inconsistent consumption changes, and so on.

Thus, to identify the characteristics that may indicate diversion, different types of the retrieved utility data are compared from the multiple sources to correlate the different types of data and identify relationships in the utility data that indicate the characteristics. In this way, the apparatus 100 identifies the characteristics, relationships, and/or anomalies within the retrieved utility data.

At 240, a theft score is calculated that identifies a likelihood that the utility resource is being diverted from a location in the geographic area. In one embodiment, the apparatus 100 calculates the theft score based, at least in part, on the identified characteristics. For example, values are assigned to each of the identified characteristics to produce the theft score based on a perceived severity of each characteristic. In one embodiment, different weights can be applied to the different identified characteristics based on how important the characteristic is believed to indicate energy diversion. A pre-defined valuation of each characteristic may be used to calculate the theft score that is based on an importance of each characteristic. Accordingly, the theft score indicates a likelihood that a location (i.e., single address, a street, or city) or point (e.g., transformer location) within the geographic area is experiencing energy diversion that amounts to theft.

At 250, the method determines whether the theft score satisfies a condition for energy diversion. For example, the theft score is compared to a threshold value. The threshold value is a value that is selected based on a sensitivity (e.g., high sensitivity for an area with a history of energy diversion) to energy diversion. If the theft score exceeds or meets the threshold value then the apparatus 100 proceeds to block 260. Otherwise, the apparatus 100 ends the inquiry for the geographic area and considers the geographic area to have a low likelihood of energy diversion. A message may be generated that indicates the result.

At 260, the apparatus 100 issues an alert message that indicates a likelihood of energy diversion in accordance with the sensitivity level that exists in the location. In one embodiment, the alert message is generated and transmitted to a management source. In this way, the message alerts sources to a possibility of energy diversion so that the energy diversion event can be remedied or investigated further. The apparatus 100 may repeat blocks 210-260 for additional geographic areas.

Additionally, in one embodiment, the analysis at 230 and the calculation of the theft score at 240 are continually refined to account for feedback and ongoing trends in the utility system data. That is, for example, when a theft score is calculated and later confirmed as identifying a location of energy diversion, factors used to perform the analysis and calculate the theft score are reinforced or adjusted based on the identified accuracy. Consider an example where spikes in energy resource usage (i.e., intermittent large increases) show a strong correlation with energy diversion. From this example, a positive identification of energy diversion occurs. Accordingly, more weight is given to spikes in usage for future theft score calculations. In this way, the analysis of the utility data and calculation of the theft score include learning/dynamic components that are refined as more utility data is analyzed to better identify sources of energy diversion.

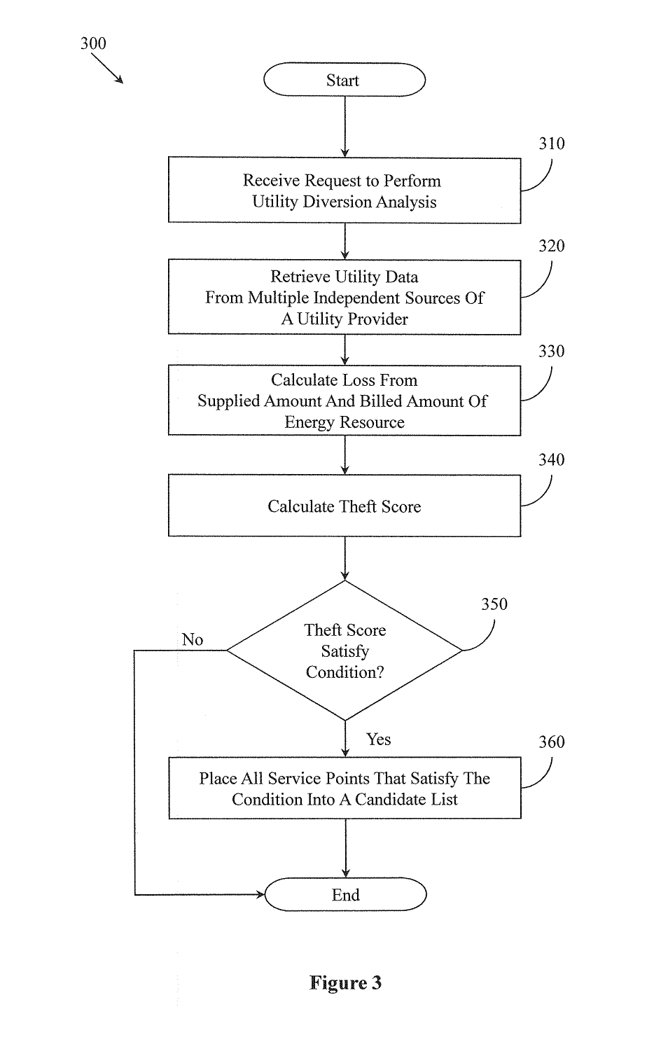

Further details of analyzing utility data to identify energy diversion within a distribution system will be discussed with reference to FIG. 3. FIG. 3 illustrates a method 300 which is an example implementation of the method 200 of FIG. 2. Accordingly, the method 300 will be discussed from the perspective of the apparatus 100 of FIG. 1.

At 310, the apparatus 100 receives a request to perform utility diversion analysis on utility data. The request specifies, for example, a geographic region within which to analyze energy resource use and also a period of time within which to analyze the energy resource use. Accordingly, at 320, the apparatus 100 retrieves utility data from the utility provider system 130 that correlates with the region and period of time. The utility data is, for example, data from several disparate enterprise systems. The utility data may include customer care data, customer data, billing data, metering data, maintenance data, outage data, and so on. Furthermore, the apparatus 100 may retrieve the utility data from different data stores that correspond to the different data sources (i.e., customer care data, billing data, etc.) or from one or more combined sources of data.

At 330, the apparatus 100 analyzes the retrieved data. For example, if the request did not specify a granularity at which to analyze the retrieved data, then the apparatus 100 begins by analyzing the retrieved data at a default level of granularity (e.g., neighborhood level). Otherwise, the apparatus 100 analyzes the retrieved data according to the specified level of granularity from the request. The apparatus 100 compares a supplied amount of the energy resource to a billed amount of the energy resource for each neighborhood in the specified geographic area.

Accordingly, for each neighborhood in the geographic area, the apparatus 100 uses, for example, a distribution point at an entry of each neighborhood to quantify how much of the energy resource was consumed by each neighborhood. In one embodiment, the distribution point is a separate physical meter at the entry point. In another embodiment, the distribution point includes data that is aggregated from all downstream meters within the neighborhood. In either case, the apparatus 100 compares the metered usage with billed usage of the energy resource for each neighborhood to determine a loss of energy for the neighborhood. The loss of energy corresponds with an initial likelihood of theft. If the loss of energy satisfies a threshold for demonstrating a likelihood of theft, then the apparatus 100 marks the neighborhood as possibly including an energy diversion event. If the loss of energy does not satisfy the threshold then, for example, the analysis ends for the particular neighborhood or whichever area is being analyzed according to the granularity level.

Additionally, in one embodiment, when the loss of energy indicates a likelihood of energy diversion, the apparatus 100 proceeds to refine the analysis at 330. That is, the apparatus 100 narrows the loss of energy analysis by increasing the granularity at which the loss of energy analysis is performed. Accordingly, if the first loss of energy analysis occurred at the neighborhood level, then the apparatus 100 may proceed to analyze the utility data by performing the loss of energy analysis at a transformer level or individual household level within that neighborhood. Thus, the apparatus 100 proceeds to perform the loss of energy analysis by iteratively determining the loss within areas that correlate with a likelihood of energy diversion until identifying, for example, a lowest level (i.e., household meter level) that has a likelihood of energy diversion. That is, if a loss of energy analysis at the transformer level indicates energy diversion but a loss calculation at the meter/house level does not, then the transformer level is identified as the likely location of the energy diversion.

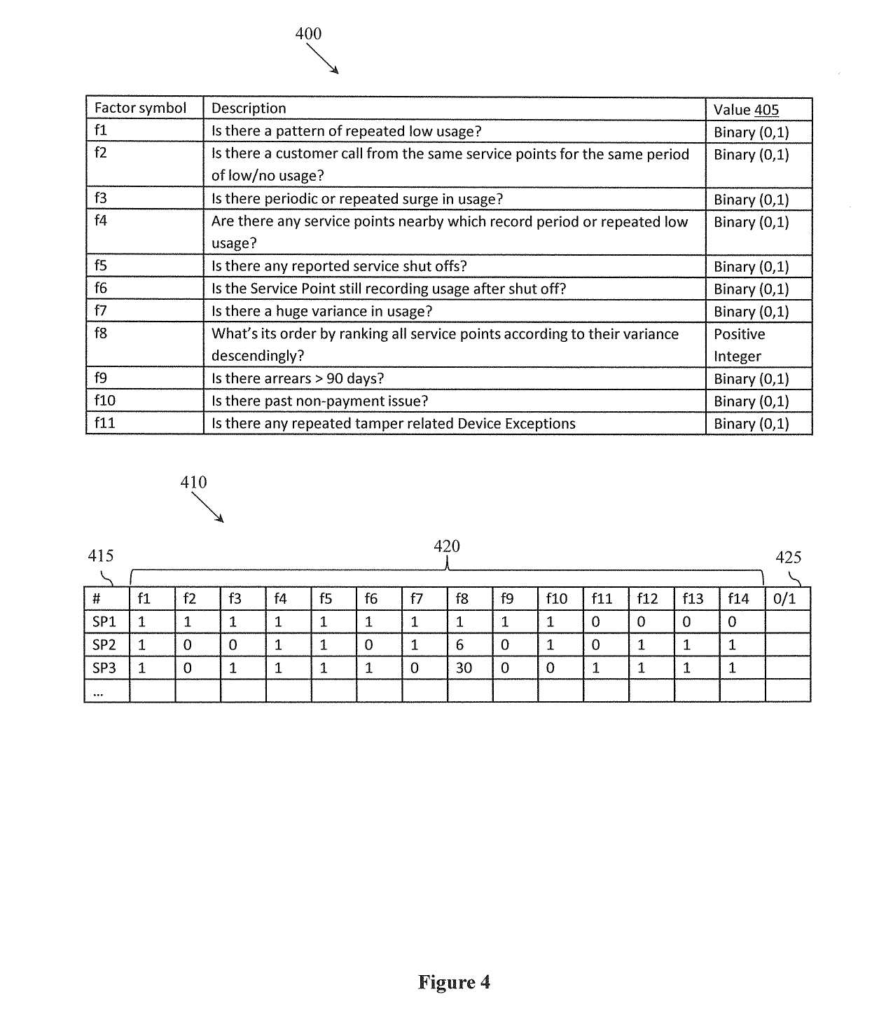

After points associated with a loss of energy are identified at 330, the apparatus 100 proceeds to 340 where further analysis of the identified points occurs. At 340, the apparatus 100 calculates a theft score for the identified points. For example, consider FIG. 4 which illustrates a factor table 400. The factor table 400 lists eleven different factors f1-f11 that are applied to utility data for points identified at 330. For example, the apparatus 100 analyzes utility data for each identified point to determine whether each factor f1-f11 exists. The apparatus 100 then applies a value for each factor f1-f11 according to a value column 405 for each factor.

For example, a theft score table 410 illustrates a set of identified points 415 (i.e., SP1-SP3) with assigned variables 420 that correlate with fourteen independent factors 420 and one dependent factor 425. The independent factors 420 correlate with the factors f1-f11 with an additional three factors that are not shown in the table 400. The dependent factor 425 is a control input for training an algorithm that provides the theft score. That is, the algorithm provides a result and if that result is confirmed as being correct or incorrect then a value (e.g., 0 or 1) can be assigned to the factor 425 for each occurrence indicating whether the occurrence correctly identified energy diversion. Coefficients in the algorithm can then be refined according to the factor 425. The theft score table 410 illustrates values for each factor that correlates with an identified point. That is, point SP1, which was identified at 330 as a likely point of energy diversion, correlates with utility data that indicates factors f1-f10 are positive and f1-f14 are negative. Thus, these values are used as inputs for the f1-f14 values in equation 1, below. An assigned value for each of the factors for an identified point (as seen in the table 410) is multiplied by an associated coefficient (e.g., c1-c14). The coefficients are, for example, weights that are applied to each factor.

f1*c1+f2*c2+f3*c3+ . . . +f14*c14=c1+c2+0+ . . . +0=estimated probability Equation 1:

A result of equation 1 for each identified point (e.g., SP1-SP3) is the theft score or estimated probability of energy diversion for the identified point that is a probability indicator (e.g., a value between zero and one). Additionally, the apparatus 100 determines the coefficients (e.g., c1-c14) on an ongoing basis to refine the equation 1. For example, identified points that are verified as being locations of energy diversion are used along with their values for the factors (e.g., f1-fn) as an input to a logistic regression algorithm. Whenever a new identified point is verified, associated values for the new point are used to update the coefficients by renewing the logistic regression. In this way, weights for each factor are updated dynamically as new points are identified.

At 350, the apparatus 100 compares a calculated theft score from equation 1 to a predetermined condition. The condition is, for example, a threshold value for determining energy diversion. That is, when the equation 1 produces an estimated probability above the threshold value then energy diversion is considered to be likely for the identified point. Thus, the apparatus 100 proceeds to 360. At 360, the apparatus 100 issues an alert by placing all service points that satisfy the condition from 350 on a candidate list. The utility provider may then further investigate identified points on the list.

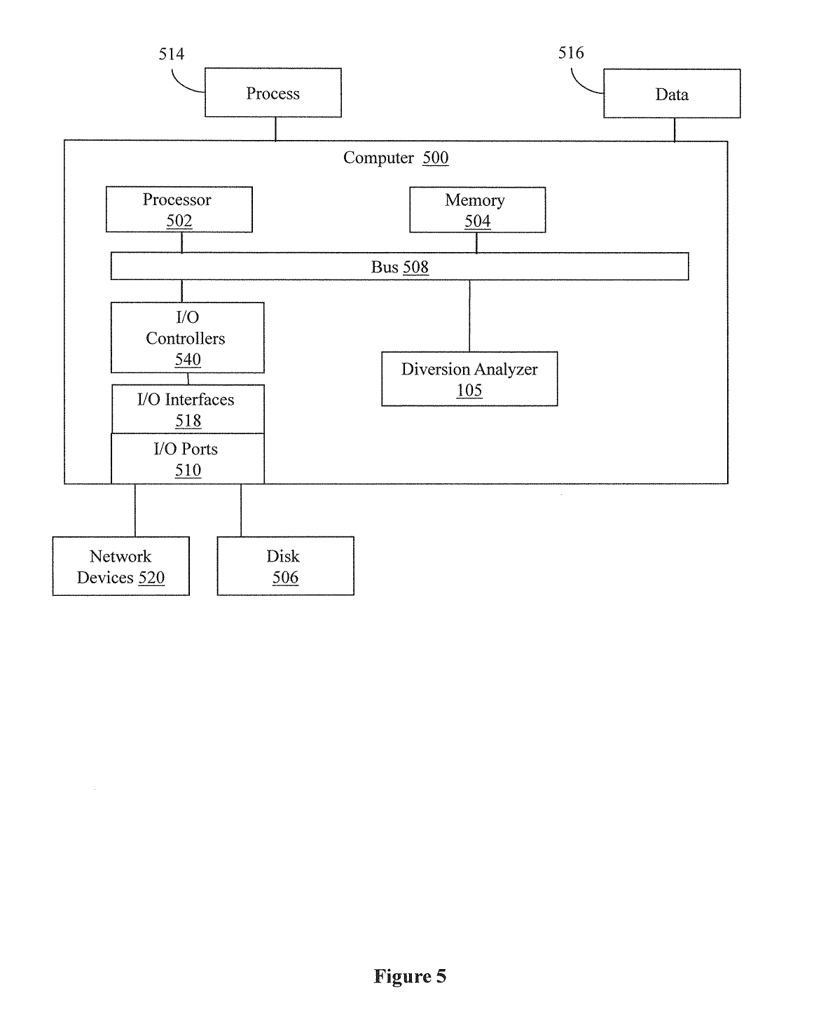

FIG. 5 illustrates one embodiment of a computing device configured with one or more of the example systems and methods described herein, and equivalents. The example computing device may be a computer 500 that includes a processor 502, a memory 504, and input/output ports 510 operably connected by a bus 508. In one example, the computer 500 is configured with the diversion analyzer 105 (shown in FIG. 1) that is configured to collect and analyze utility data to identify energy diversion within a distribution system of a utility provider. In one embodiment, the diversion analyzer 105 is configured to perform the method of FIG. 2. In different embodiments, the diversion analyzer 105 may be implemented in hardware, logic, a non-transitory computer-readable medium with stored executable instructions that cause the computer/processor to perform the functions, firmware, and/or combinations thereof. While the diversion analyzer 105 is illustrated as a hardware component attached to the bus 508, it is to be appreciated that in one example, the diversion analyzer 105 could be implemented in the processor 502.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The bus 508 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The computer 500 may interact with input/output devices via the i/o interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Data store”, as used herein, refers to a physical entity that can store data on a non-transitory computer readable medium.

“Logic”, as used herein, includes but is not limited to computer or electronic hardware, firmware, a non-transitory computer readable medium that stores instructions, and/or combinations of each to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Query”, as used herein, refers to a semantic construction that facilitates gathering and processing information. A query may be formulated in a database query language (e.g., SQL), an OQL, a natural language, and so on.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this disclosure is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

What is claimed is:

1. A non-transitory computer-readable medium storing computer-executable instructions that when executed by a computer cause the computer to perform a method, the method comprising:
retrieving, by at least a processor of the computer, utility data associated with a geographic area, wherein the utility data is retrieved from multiple independent sources of a utility provider;
analyzing the utility data based, at least in part, on diversion rules to identify characteristics that correlate with diversion of a utility resource; and
calculating a theft score that identifies a likelihood that the utility resource is being diverted from a location in the geographic area based, at least in part, on the identified characteristics.

2. The non-transitory computer-readable medium of claim 1, wherein retrieving the utility data from multiple independent sources includes retrieving a first portion of the utility data from a first database that stores billing data, retrieving a second portion of the utility data from a second database that stores metering data, and retrieving a third portion of the utility data from a third database that stores customer data, and wherein the first, second and third databases are part of independent enterprise systems of the utility provider.

3. The non-transitory computer-readable medium of claim 1, wherein analyzing the utility data based, at least in part, on the diversion rules includes comparing different types of the utility data from the multiple sources to correlate the different types of data and identify relationships in the utility data that indicate the characteristics that correlate with diversion.

4. The non-transitory computer-readable medium of claim 1, wherein the characteristics that correlate with diversion of a utility resource include payment pattern changes, consumption changes, tampering events, or validate edit estimate (VEE) events.

5. The non-transitory computer-readable medium of claim 1, further comprising:
receiving, in the computer, a request to perform a utility diversion analysis, wherein the request specifies the geographic area within which to perform the utility diversion analysis; and
in response to the theft score satisfying a condition for diversion of the utility resource, issuing an alert to a management source.

6. The non-transitory computer-readable medium of claim 1, wherein the diversion of the utility resource is an unauthorized taking of the utility resource from a utility distribution system of the utility provider.

7. The non-transitory computer-readable medium of claim 1, wherein the utility resource is electric, gas, water, or telephony resources, and wherein analyzing the utility data based, at least in part, on the diversion rules to identify the characteristics includes comparing in-flow of the utility resource for the geographic area against metered usage for the geographic area.

8. The non-transitory computer-readable medium of claim 1, wherein calculating the theft score includes weighing each of the identified characteristics according to a pre-defined valuation, and wherein the characteristics include anomalies based on a threshold comparison of the utility data with expected values.

9. An apparatus, the apparatus comprising:
analysis logic configured to retrieve utility data associated with a geographic area, and to analyze the utility data based, at least in part, on diversion rules to identify characteristics that correlate with diversion of a utility resource, wherein the utility data is retrieved from multiple independent sources of a utility provider; and
theft logic configured to calculate a theft score that identifies a likelihood that the utility resource is being diverted from a location in the geographic area based, at least in part, on the identified characteristics.

10. The apparatus of claim 9, wherein the analysis logic is configured to retrieve the utility data from multiple independent sources via a communications network by retrieving a first portion of the utility data from a first database that stores billing data, retrieving a second portion of the utility data from a second database that stores metering data, and retrieving a third portion of the utility data from a third database that stores customer data, and wherein the first, second and third databases are part of independent enterprise systems of the utility provider.

11. The apparatus of claim 9, wherein the analysis logic is configured to analyze the utility data based, at least in part, on the diversion rules by comparing different types of the utility data from the multiple sources to correlate the different types of data and identify relationships in the utility data that indicate the characteristics.

12. The apparatus of claim 9, wherein the characteristics that correlate with diversion of a utility resource include payment pattern changes, consumption changes, tampering events, or validate edit estimate (VEE) events.

13. The apparatus of claim 9, wherein the diversion of the utility resource is an unauthorized taking of the utility resource from a utility distribution system of the utility provider.

14. The apparatus of claim 9, wherein the utility resource is electric, gas, water, or telephony resources, and wherein the analysis logic is configured to analyze the utility data based, at least in part, on the diversion rules to identify the characteristics by comparing in-flow of the utility resource for the geographic area against metered usage for the geographic area.

15. The apparatus of claim 9, wherein the theft logic is configured to calculate the theft score by weighing each of the identified characteristics according to a pre-defined valuation, and wherein the characteristics include anomalies based on a threshold comparison of the utility data with expected values.

16. A method, the method comprising:
analyzing, by at least a processor of a computer, utility data based, at least in part, on diversion rules to identify characteristics that correlate with diversion of a utility resource, wherein the utility data is data from multiple independent sources of a utility provider; and
calculating a theft score that identifies a likelihood that the utility resource is being diverted from a location in a geographic area based, at least in part, on the identified characteristics.

17. The method of claim 16, comprising:
retrieving the utility data associated with the geographic area, wherein the utility data is retrieved from the multiple independent sources of the utility provider, wherein retrieving the utility data from multiple independent sources includes retrieving a first portion of the utility data from a first database that stores billing data, retrieving a second portion of the utility data from a second database that stores metering data, and retrieving a third portion of the utility data from a third database that stores customer data, and wherein the first, second and third databases are part of independent enterprise systems of the utility provider.

18. The method of claim 16, wherein analyzing the utility data based, at least in part, on the diversion rules includes comparing different types of the utility data from the multiple sources to correlate the different types of data and identify relationships in the utility data that indicate the characteristics that correlate with diversion.

19. The method of claim 16, wherein the characteristics that correlate with diversion of the utility resource include payment pattern changes, consumption changes, tampering events, or validate edit estimate (VEE) events.

20. The method of claim 16, wherein the diversion of the utility resource is an unauthorized taking of the utility resource from a utility distribution system of the utility provider, wherein analyzing the utility data based, at least in part, on the diversion rules to identify the characteristics includes comparing in-flow of the utility resource for the geographic area against metered usage for the geographic area, and wherein the characteristics include anomalies based on a threshold comparison of the utility data with expected values.
